(19) United States
(12) Patent Application Publication
(10) Pub. No.: US 2007/0060731 A1
(43) Pub. Date: Mar. 15, 2007

(54) Method for the production of prepolymers containing isocyanate groups

(75) Inventors: Michael Wind, Kalletal (DE); Martin Kreyenschmidt, Lohne (DE); Imbridt Murrar, Senftenberg (DE); Hans-Jurgen Reese, Olching (DE); Heiko Urtel, Edingen-Neckarhausen (DE); Hauke Malz, Diepholz (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/577,723

(22) PCT Filed: Oct. 30, 2004
(86) PCT No.: PCT/EP04/12335

§ 371 Date: May 2, 2006

(30) Foreign Application Priority Data
Nov. 3, 2003 (DE) 103 51 530.5

(51) Int. Cl. C08G 18/00

(52) U.S. Cl. 528/44

(57) ABSTRACT

The invention relates to a process for preparing prepolymers containing isocyanate groups by reacting a) diisocyanates with b) compounds having at least two hydrogen atoms which are reactive toward isocyanate groups in the presence of c) catalysts, and subsequently separating off the excess monomeric diisocyanates, wherein the diisocyanates a) used are unsymmetrical diisocyanates and the catalysts c) used are organometallic catalysts and these organometallic catalysts are removed, blocked or deactivated before the monomeric diisocyanates are separated off.

The invention relates to a process for preparing prepolymers which contain isocyanate groups and have a low degree of polymerization and a narrow molecular weight distribution and also have a low content of monomeric diisocyanate.

Prepolymers containing urethane groups and terminal isocyanate groups are important intermediates for the production of polyurethanes. They have been known for a long time and are widely described in the literature.

They are prepared by reacting compounds having at least two hydrogen atoms which are reactive toward isocyanate groups, in particular polyols, with an excess of polyisocyanates.

The urethane reaction of the at least bifunctional isocyanate with the at least bifunctional polyol also forms oligomeric products beyond the stoichiometric reaction product, since each intermediate contains reactive NCO or OH groups which can in turn react further with starting materials or other intermediates which have already been formed. The formation of such oligomeric polyurethanes is undesirable when, for example, defined A-B-A structures of isocyanate and polyol are to be built up. Such defined structures have a positive effect on the property profile of foamed and compact elastomers such as thermoplastic polyurethanes or pourable elastomers. Furthermore, the prepolymer viscosity generally increases with the degree of polymerization. Highly viscous prepolymers generally restrict further processing, especially in 2-component systems, to a considerable extent, since the miscibility of isocyanate and polyol components is impaired.

In the preparation of the prepolymers containing isocyanate groups, unreacted monomers of the diisocyanate used in excess usually remain in the prepolymer regardless of the reaction time. This residual content of monomeric diisocyanate can cause problems in the use of isocyanate prepolymers or in their further processing. Thus, some of the monomers, for example tolylene diisocyanate (TDI) or the aliphatic diisocyanates hexamethylene 1,6-diisocyanate (HDI) and isophorone diisocyanate (IPDI) have an appreciable vapor pressure even at room temperature and therefore have a toxic effect, particularly in spray applications due to the isocyanate vapors occurring there. In use at elevated temperatures as are frequently necessary, for example, in the processing of adhesives, the isomers of diphenylmethane diisocyanate (MDI) also form aerosol or gaseous emissions. Since costly measures for maintaining the purity of, in particular, air breathed in are generally prescribed by law to protect a person carrying out the processing, the user has an interest in diisocvanate-free prepolymers. Furthermore, monomeric diisocyanates themselves or in the form of their reaction products with amines can in the presence of moisture form “migrates” which migrate in an undesirable manner from the finished polyurethane product to its surface and from there, as in the case of vehicle interiors, into the ambient air or, as in the case of packaging films, into the product which has been packed. In addition, monomeric MDI tends to crystallize in the prepolymer.

In the case of conventional prepolymers which still contain significant amounts of monomeric diisocyanate, the product properties, for example the viscosity, are determined predominantly by the unreacted, free diisocyanate. Only in the case of polyurethane prepolymers having a low content of free diisocyanate, for example on the basis of tolylene diisocyanate (TDI) or diphenylmethane diisocyanate (MDI), as are now demanded by the market for the reasons mentioned does the formation of oligomeric products have a substantial influence on the product viscosity and other polymer-physical parameters of the system. The opportunity of carrying out a controlled reaction to control the degree of polymerization would be particularly desirable for the latter cases.

The product distribution in the prepolymer is influenced decisively by the molar ratio of the starting materials to one another. Thus, the groups which can undergo an addition reaction have to be present in close to equimolar amounts in order to achieve high molecular weights. The result is broad molecular weight distributions having a low molar proportion of the individual fractions.

As the stoichiometric excess of one component increases, the mean degree of polymerization is reduced and the formation of higher molecular weight adducts is suppressed. The product distribution can, in the case of the reaction of symmetrical diisocyanates and diols, be calculated with the aid of a statistical formula, namely the Flory distribution. If, for example, one mol of diol is reacted with two mol of diisocyanate, with both hydroxyl and isocyanate groups having the same reactivity, (r₀=0.5, r₀ is the molar ratio of the isocyanate component to the polyol component), the diurethane is formed to an extent of only 25%, while in the case of a molar excess of diisocyanate:diol of 5:1 or 7:1 it is formed to an extent of 47% or 58%, respectively. In the limiting case where r₀=n_{diisocyanate}/n_{diol}<<1, the yield of 2:1 adduct of isocyanate and polyol can be theoretically close to 100% of the molar formula conversion.

However, the large molar excess of monomeric diisocyanate remaining in the product may then have to be removed again, which costs money. This can be achieved by distillation, solvent extraction or filtration and is described, for example, in WO 01/40342. The use of high molar excesses of free isocyanate should therefore be avoided where possible.

A further possible way of suppressing the formation of relatively high molecular weight adducts in the preparation of the prepolymers is the use of diisocyanates having isocyanate groups of differing reactivity. Common, commercially available examples of such diisocyanates, hereinafter referred to as unsymmetrical diisocyanates, are 2,4-TDI, 2,4′-MDI and IPDI. However, the resulting molecular weight distribution can then no longer be described by a simple statistical formula as has been discussed above. Rather, the calculation of the individual molar product fractions has to be carried out, for example, on the basis of kinetic simulations in which the relative reactivities of the two NCO groups, which have to be determined independently by experiment, are required as input.

When 2,4-TDI, in which the difference in the reactivity of the two isocyanate groups is very pronounced, is used, diisocyanate-free prepolymers having a narrow molecular weight distribution can be obtained at a moderate stoichiometric excess of the isocyanate component, even without additional purification steps.

In the case of 2,4′-MDI, which owing to its relatively low volatility is difficult to remove anyway, the reactivity difference of the isocyanate groups is far less strongly pronounced. Low degrees of polymerization can be achieved for 2,4′-MDI only by use of still considerable stoichiometric isocyanate excesses, which may then have to be removed again at some cost.

The prior art discloses a number of processes for preparing prepolymers which contain isocyanate groups and have a defined structure, in which processes unsymmetrical diisocyanates are used as diisocyanates.

Thus, DE 102 29 519 A1 describes a process for preparing prepolymers which contain isocyanate groups and have a low content of monomeric diisocyanate without an additional work-up step. This process uses unsymmetrical diisocyanates as diisocyanates. A ratio of NCO groups to OH groups of from 1.1 to 2.0 is employed. The MDI prepolymers prepared according to the teachings of DE 102 29 519 A1 have a comparatively high viscosity, which indicates a significant proportion of high molecular weight material in the prepolymer.

WO 03/033562 describes binders for reactive 1C melt adhesives or solvent-containing PUR adhesives based on 2,4′-MDI and polyols having, compared to a corresponding 4,4′-MDI formulation, a reduced content of monomeric diisocyanate and a reduced viscosity. Here too, a small excess of diisocyanate is employed, which leads to a high viscosity of the product.

DE 101 57 488 describes the preparation of isocyanate prepolymers having a low content of monomeric polyisocyanate of less than 2% by weight. One of the starting materials for the prepolymer is a monomer-free prepolymer prepared on the basis of 4,4′-MDI.

There are also documents which describe defined A-B-A structures of isocyanate and polyol and processes for preparing them.

Thus, EP 1 253 159 describes the preparation of prepolymers which contain isocyanate groups and have a high content of material having the structure ABA, where A is a radical of a diisocyanate and B is the radical of a diol. As diisocyanates, a number of conventional and known diisocyanates is proposed, with no distinction being made between symmetrical and unsymmetrical diisocyanates. The prepolymers are prepared without use of catalysts and using a very high equivalent excess of diisocyanates, in the case of TDI from 6:1 to 10:1, which subsequently has to be removed at some cost for many applications of the prepolymers.

WO 01/40340 A2 describes the preparation of ABA prepolymers, with TDI being used as isocyanate. The removal of the excess of monomeric diisocyanate by distillation is carried out in the presence of at least one inert solvent.

EP 1 249 460, too, describes prepolymers having A-B-A structures, but the content of 2,4′-MDI in the diisocyanate used is not more than 70%.

Finally, EP 0 370 408 describes prepolymers having a proportion of at least 85% of perfect A-B-A, but alkyl-substituted TDI derivatives are used as isocyanate component A.

WO 03/46040 describes prepolymers which contain isocyanate groups and are low in monomers and are prepared by reaction of both symmetrical and unsymmetrical diisocyanates with diols. Here, conventional catalysts such as amines or organometallic catalysts can be used in the preparation.

DE 101 61 386 describes low-monomer prepolymers which are based on IPDI and polyols and have been prepared by means of DMC catalysis. No removal of monomers from the prepolymers is carried out, and the content of free IPDI is very high at almost 2% by weight.

It was an object of the invention to develop a process for preparing prepolymers which contain isocyanate groups and have a low proportion of monomeric diisocyanate, preferably less than 0.1% by weight and in particular less than 0.05% by weight, a low degree of polymerization and a narrow molecular weight distribution.

This object has been able to be achieved by using unsymmetrical diisocyanates, in particular 2,4-TDI, 2,4′-MDI and/or IPDI, as diisocyanates, carrying out the reaction in the presence of organometallic catalysts, then removing these organometallic catalysts from the reaction product or deactivating them and subsequently separating off excess monomeric diisocyanate from the reaction product.

The invention accordingly provides essentially a process for preparing prepolymers containing isocyanate groups by reacting

a) diisocyanates with

b) compounds having at least two hydrogen atoms which are reactive toward isocyanate groups in the presence

c) of catalysts, and subsequently separating off the excess monomeric diisocyanates,

wherein

the diisocyanates a) used are unsymmetrical diisocyanates and the catalysts c) used are organometallic catalysts and these organometallic catalysts are removed, blocked or deactivated before the monomeric diisocyanates are separated off.

Blocking of the catalysts is usually achieved by addition of a blocking agent.

Deactivation of the catalysts can be effected, for example, by means of chemical modification such as hydrolysis or reduction.

Removal of the catalysts can be carried out by filtration.

The catalysts can be homogeneous catalysts, heterogeneous catalysts or supported catalysts. In the case of supported catalysts, the homogeneous catalysts are applied to a support. The catalysts are described in more detail below.

For the purposes of the present invention, unsymmetrical diisocyanates are diisocyanates whose isocyanate groups have different reactivities. Preference is given to using 2,4-TDI, 2,4′-MDI and/or isophorone diisocyanate (IPDI) as unsymmetrical diisocyanates. Particular preference is given to 2,4′-MDI. Unsymmetrical diisocyanates can also be used in admixture with symmetrical diisocyanates or polymeric isocyanates, with the proportion of the unsymmetrical diisocyanates in the mixture being greater than 30% by weight, preferably greater than 60% by weight and particularly preferably greater than 90% by weight.

It has been found that the use of organometallic compounds as catalyst leads to isocyanate prepolymers having a low degree of polymerization. Catalysts which can be used according to the invention are, for example, organometallic compounds of the metals of groups IVA (Ge, Sn, Pb), VA (Sb, Bi), IVB (Ti, Zr, Hf), VB (V, Nb, Ta) or VIIIB (in particular Fe, Co, Ni, Ru). Suitable ligands are, for example, carboxylate anions, alkoxides, enolates, thiolates, mercaptides and alkyl ligands. These ligands can also be used in the form of chelating systems. Examples which may be mentioned are the complexes bismuth(III) tris(2-ethylhexanoate), iron(III) acetate and zirconium(IV) propoxide. Catalysts which are particularly preferred for the purposes of the invention are organometallic compounds from the group of tin(IV) compounds. These catalysts display a particularly high selectivity in respect of the reaction of the more reactive isocyanate group, in particular when using 2,4′-MDI as diisocyanate. Specific compounds are: dimethyltin, dibutyltin and dioctyltin dilaurate, bis(dodecylmercaptide), bis(2-ethylhexylthioglycolate), diacetate, maleate, bisthioglycerol; octyltin tris(2-ethyl-hexylthioglycolate) and bis(□-methoxycarbonylethyl)tin dilaurate. Preference is also given to organometallic Ti(IV) catalysts. Specific Ti(IV) compounds which may be mentioned are: tetraisopropyltitanium, tetra-tert-butylorthotitanium, tetra(2-ethylhexyl)-titanium and bis(ethylacetoacetato)titanium diisopropoxide. Organobismuth compounds, particularly in the form of their carboxylates, have also been found to be usable. Examples which may be mentioned are bismuth(III) tris(2-ethylhexanoate) and laurate. It is also possible to use mixtures of metal catalysts, in particular mixtures of those mentioned.

The organometallic catalysts used according to the invention are preferably employed in an amount in the range from 0.1 to 5000 ppm, preferably from 1 to 200 ppm and particularly preferably from 1 to 30 ppm, based on the reaction mixture. In the case of low concentrations, the action of the catalysts is not very pronounced. Excessively high catalyst concentrations lead to increased formation of undesirable by-products such as allophanates, isocyanate dimers and trimers or ureas. The optimum amount of catalyst in an individual case can easily be determined by means of a few orientating experiments.

Since organometallic catalysts can cause problems in the removal of the monomeric diisocyanates, in particular by distillation, it is necessary for them to be deactivated or separated off subsequent to the prepolymer synthesis. Under the increased thermal stress of the distillation, catalysts can also catalyze urethane dissociation, which can lead to an undesirable increase in the degree of polymerization.

In the past, the positive effects resulting from the use of the catalysts mentioned were not utilized in the preparation of low-monomer prepolymers containing isocyanate groups, since degradation of the prepolymers occurred when the excess monomers were separated off. For this reason, the use of catalysts was usually avoided.

The destillation to separate off excess monomeric diisocyanate is preferably carried out in the presence of a blocking agent for the organometallic catalyst. Such blocking agents are generally metal deactivators and act by complexing the metallic central atom of the organometallic catalyst. Examples of such Lewis-acid metal deactivators are 2-(2-benzimidazolyl)phenol, 3-(2-imidazolin-2-yl)-2-naphthol, 2-(2-benzoxazolyl)-phenol, 4-diethylamino-2,2′-dioxy-5-methylazobenzene, 3-methyl-4-(2-oxy-5-methylphenylazo)-1-phenyl-5-pyrazolone, tris(2-tert-butyl-4-thio(2′-methyl-4′-hydroxy-5′-tert-butyl)phenyl-5-methyl) phenylphosphite, decamethylenedicarboxydisalicyloyl hydrazide, 3-salicyloylamino-1,2,4-triazole, 2′,3-bis((3-(3,5-di-tert-butyl-4-hydroxyphenyl)propionyl))propione hydrazide and 2,2′-oxamidobis(ethyl-3-(3,5-di-tert-butyl-4-hydroxyphenyl) propionate).

However, it has surprisingly been found that particularly good results can be achieved using metal deactivators which have a structure of the general formula (I)
R₁-X₁-C(X₂,R₂)-(CH₂)ₙ-C(X₃,R₃)-X4-R4 (I) .

R₁ and R₄ are, independently of one another, any organic radicals such as a linear, branched or cyclic alkyl radical, a linear, branched or cyclic alkenyl radical, a linear, branched or cyclic hydroxy, halogen, amino or thioalkyl radical. R₂ and R₃ are each, independently of one another, either nothing or hydrogen. X₁ and X₄ are each, independently of one another, either nothing or oxygen. X₂ and X₃ are Lewis-acid substituents, for example a halogen, O, OH, NH₂, NO₂, SH. n is an integer from 1 to 5, preferably 1.

Particularly useful compounds of the general formula (I) have been found to be organic carboxylic acids which are functionalized on the β-carbon atom (C3) relative to the carbon atom (C1) of the acid group (-C(1)OOH) and in particular their esters from the group consisting of β-hydroxycarboxylic acids, β-aminocarboxylic acids, β-ketocarboxylic acids and 1,3-dicarboxylic acids. Specific compounds which may be mentioned are citric acid, malic acid, tartaric acid, acetoacetic acid, 2-chloroacetoacetic acid, benzoylacetic acid, acetonedicarboxylic acid, dehydroacetic acid, 3-oxovaleric acid and malonic acid and also the associated esters in each case, for example in the form of their methyl or ethyl esters.

In a particularly preferred embodiment of the invention, esters in which R₁ or R₄ is a hydroxyl-terminated alkyl radical having a mean molecular weight M_{W} of from 170 to 10 000 g mol⁻¹, in particular from 170 to 450 g mol⁻¹, are used as metal deactivaters. The preparation of these polymeric blocking compounds is carried out by esterification of the pure carboxylic acids or by transesterification of, for example, methyl and ethyl esters with polyols having a mean molecular weight M_{W} of from 170 to 10 000 g mol⁻¹, in particular from 170 to 450 g mol⁻¹, and a functionality of from 1 to 4, in particular from 1.7 to 2.5. The polyols mentioned are usually addition products of lower alkylene oxides, in particular ethylene oxide and/or propylene oxide, onto H-functional starter substances.

These polymeric metal deactivators are particularly suitable for the process of the invention because they are not volatile or only slightly volatile under the thermal stress of the distillation to remove the monomeric diisocyanate and can therefore effectively complex the organometallic catalyst to the end of the distillation. Particularly useful blocking agents are those whose boiling point at the same pressure is higher than that of the isomers of MDI, whose boiling point at 0.1 bar is greater than 250° C.

The metal deactivator is preferably added to the isocyanate prepolymer immediately after its synthesis in a 10- to 10 000-fold, preferably a 10- to 50-fold, molar excess, based on the amount of the metal catalyst utilized which is used.

Furthermore, compounds from the group consisting of 1,3-diketones, β-hydroxyketones, 1,3-diols and β-aminoalcohols have been found to be usable.

In a particular embodiment of the invention, hydrazine derivatives of salicylaldehyde, for example decamethylenedicarboxydisalicyloyl hydrazide and 3-salicyloylamino-1,2,4-triazole, are utilized as metal deactivators.

It has surprisingly been found that particularly good results are achieved using metal deactivators which are triazole and hydrazine derivatives of salicylaldehyde.

Examples of such structures are decamethylenedicarboxydisalicyloyl hydrazides (ADK Stab CDA 6®) and 3-salicyloylamino-1,2,4-triazole (ADK Stab CDA 1®). Particular preference is given to decamethylenedicarboxydisalicyloyl hydrazides. It can be advantageous to use not a single metal deactivator but mixtures of metal deactivators. Preference is given to mixtures comprising salicyloylamino-1,2,4-triazole and/or decamethylenedicarboxydisalicyloyl hydrazides, in particular mixtures containing decamethylenedicarboxydisalicyloyl hydrazides.

In a particular embodiment of the invention, organometallic catalysts which have been applied to a support material are used. These are referred to below as supported catalysts. The supported catalyst can easily be separated from the isocyanate prepolymer by filtration subsequent to the prepolymer synthesis.

For the purposes of the present invention porous support materials, which may be from the group consisting of organic and inorganic materials and also inorganic oxides, are generally suitable. Preferred support materials are carbon materials (e.g. activated carbons or carbon blacks), silicon carbide, aluminum oxide, zirconium dioxide, silicon dioxide, titanium dioxide, zeolites, vanadium oxide, tungsten oxide, alkaline earth metal oxides and carbonates, iron oxide, zinc oxide, magnesium oxide, aluminum phosphates, titanium silicates, mixed oxides, talc, clay and mixtures thereof. Further support materials which can be used are solid paraffin and polymers of vinyl chloride, of ethylene, of propylene, of styrene, of acrylates, substituted derivatives of the polymers mentioned and copolymers of them.

For the purposes of the present invention, porous carbon supports which can be procured from many commercial suppliers have been found to be particularly useful. The carbon supports used according to the invention have a specific surface area of from 0.5 to about 3000 m²/g (determined in accordance with DIN 66 131), a pore volume in the range from 0.01 ml/g to 2 ml/g (determined in accordance with DIN 66 134 and DIN 66 135). Preference is given to porous carbon supports having a specific surface area of from 1 to 1000 m²/g. Carbon supports having a specific surface area of from 5 to 500 m²/g are particularly preferred.

The carbon supports can optionally be pretreated by customary methods such as acid activation, for example by means of nitric acid, phosphoric acid or formic acid, calcination or impregnation, for example with alkali metal salts, prior to application of the catalytically active compound.

The application of a catalyst to the support material is carried out by methods of the prior art. From 0.5 to 40% by weight of the metal, based on the total weight of the catalyst, are applied to the support. The supported catalysts particularly preferably contain from 1 to 20% by weight of the metal.

In one possible method of preparing the supported catalysts, a solution containing the desired amount of the organometallic compound is prepared first, and the support material is then added to this. Evaporation of the solvent gives a heterogeneous catalyst having the appropriate amount of active composition on the support material. Thus, for example, it is possible to introduce a carbon support into a solution of dibutyltin dilaurate in ethanol while stirring and obtain the catalyst by evaporation of the ethanol and subsequent drying.

The supported catalysts are used in a concentration of from 0.001 to 5% by weight, in particular from 0.01 to 0.1% by weight and particularly preferably from 0.1 to 0.5% by weight, based on the reaction mixture.

A further possible way of immobilizing the organometallic catalysts on the support is chemical anchoring on a Merrifield resin. It is also possible to use organometallic complexes which have an unsaturated carbon ligand which on polymerization leads to a readily filterable catalyst. An example of a suitable compound is a compound of the type Sn((CH₂)₃CHCH₂)(R)₂R′ where R, R′=alkyl, aryl, alkoxy). In a further particular embodiment of the invention, the homogeneous catalysts are removed from the reactive isocyanate prepolymer by means of adsorptive materials. The adsorption can be carried out using the same materials as have been mentioned for supporting the organometallic catalysts.

Chemical deactivation of the catalyst, for example by reduction or hydrolysis, represents a further but not preferred embodiment of the invention. A further, not preferred embodiment is the use of Lewis-acid heterogeneous catalysts. These heterogeneous catalysts can be metals, metal oxides or metal halides of the chemical groups 2, 3, 4, 5, 6, 8, 9, 10, 13, 14 and also mixtures thereof. Examples which may be mentioned are: calcium oxide, barium oxide, titanium oxide, vanadium oxide, tungsten oxide, iron oxides, platinum oxide, zinc oxide, zirconium dioxide, lanthanum oxides, aluminum oxide and silicon oxide.

In a further embodiment of the invention, the various methods of deactivating the organometallic catalysts which have been described, i.e. deactivation by means of blocking agents, application of homogeneous catalysts to a support or the use of Lewis-acid catalysts with subsequent filtration, adsorption of the metal catalyst or chemical deactivation by hydrolysis or reduction, can also be combined in any desired way.

It is surprising that the object of the invention has been able to be achieved by the use of the organometallic catalysts used according to the invention and their subsequent removal or transformation. This is particularly surprising since when customary amine catalysts are used, the selectivity of the two isocyanate groups of the unsymmetrical diisocyanates is significantly worsened and in many cases is lower than in the reaction without catalysts.

As compounds having at least two hydrogen atoms which are reactive toward isocyanate groups for preparing the prepolymers, preference is given to using compounds which have at least two hydroxyl and/or amino groups in the molecule. In particular, these compounds have a molecular weight Mn of from 60 to 10 000 g/mol. The compounds having at least two hydrogen atoms which are reactive toward isocyanate groups are particularly preferably selected from the group consisting of polyhydric alcohols, polyether alcohols, polyester alcohols, polyetherpolyamines, hydroxyl-containing polycarbonates, hydroxyl-containing polyacetals and any mixtures of at least two of these compounds. Particular preference is given to polyhydric alcohols and polyether alcohols and also mixtures thereof.

Examples of polyhydric alcohols are alkanediols having from 2 to 10, preferably from 2 to 6, carbon atoms and also higher alcohols such as glycerol, trimethylolpropane or pentaerythritol. It is also possible to use natural polyols such as castor oil. The polyether alcohols preferably have a functionality in the range from 2 to 8. They are usually prepared by addition of alkylene oxides, in particular ethylene oxide and/or propylene oxide, onto H-functional starter substances. The alkylene oxides can be used individually, in succession or as a mixture. Examples of possible starter substances are water, diols, triols, higher-functionality alcohols, sugar alcohols, aliphatic or aromatic amines or amino alcohols.

Polyether alcohols having a mean molecular weight of from 500 to 3000 g/mol and a mean OH functionality of from 2 to 3 are particularly useful. Particularly preferred starter substances for preparing these polyether alcohols are propylene glycol and glycerol. Preferred alkylene oxides are ethylene oxide and propylene oxide.

Preference is likewise given to polyester alcohols having a mean molecular weight of from 1000 to 3000 g/mol, and a mean OH functionality of from 2 to 2.6. Particular preference is given to polyester alcohols based on adipic acid.

The prepolymers are prepared, as indicated, by reacting the polyisocyanates with the compounds having at least two hydrogen atoms which are reactive toward isocyanate groups.

The reaction of the diisocyanates with the compounds having at least two hydrogen atoms which are reactive toward isocyanate groups can be carried out continuously or batchwise in customary reactors, for example known tube reactors or stirred tank reactors, if appropriate in the presence of inert solvents, i.e. compounds which are not reactive toward the isocyanates and OH-functional compounds.

The selectivity of the urethane reaction of unsymmetrical isocyanates is increased further in the presence of inert solvents. Examples of inert solvents are acetone, dichloromethane, ethyl acetate and toluene. The reaction can be carried out in the presence of inert solvents at relatively low temperatures. The reaction is generally carried out in a temperature range from 0 to 100° C., in particular from 20 to 40° C. The proportion by mass of solvent in the total reaction mixture is from 5 to 60% by weight, in particular from 20 to 50% by weight.

To obtain a very high proportion of oligomers having a diisocyanate unit on each hydroxyl group, it is advantageous to employ an excess of diisocyanate. The ratio of isocyanate groups to groups which are reactive toward isocyanate groups is generally in the range from 1:1 to 10:1, preferably from 1:1 to 7:1 and particularly preferably from 1:1 to 5:1. At a given excess of diisocyanate, i.e. also at moderate excesses in the range from 1:1 to 1:3, products having a lower degree of polymerization and a narrower molecular weight distribution are generally obtained when the synthesis of reactive isocyanates is carried out according to the invention than in processes according to the prior art.

Since, as indicated at the outset, the proportion of monomeric diisocyanates in the prepolymer should be low, the unreacted diisocyanate has to be removed from the prepolymer after the reaction. This can be achieved in a customary way, for example by distillation, preferably thin film distillation, or particularly preferably by use of at least one short path evaporator as described, for example, in WO 03/46040.

Since a smaller excess of diisocyanate can be employed in the process of the invention, the amount of diisocyanate to be removed is also lower than in processes of the prior art. Prepolymers which are free of monomeric diisocyanate and have a given degree of polymerization and a given molecular weight distribution and thus, for example, a given viscosity can in this way be prepared in a higher yield based on the prepolymer synthesis and at an increased throughput based on the removal of the excess monomeric diisocyanate, i.e. with overall improved economics, compared to processes of the prior art.

The reactive isocyanate prepolymer obtained in this way preferably contains from 0.01 to 0.5% by weight, preferably from 0.02 to 0.09% by weight, of monomeric diisocyanate. The NCO content of the reactive isocyanate prepolymers of the invention is from 3 to 14% by weight, in particular from 5 to 9% by weight. The viscosity of the reactive isocyanate prepolymers of the invention is, at 50° C., from 100 mPas to 100 000 mPas, preferably from 1000 mPas to 40 000 mPas, measured by the Brockfield method (ISO 255).

Furthermore, the prepolymers of the invention have a narrow molecular weight distribution, a low degree of polymerization and a content of ABA structures of at least 80% by area, based on the prepolymer. The % by area were determined by means of gel permeation chromatography (GPC).

The prepolymers of the invention containing isocyanate groups and urethane groups are usually employed for producing polyurethanes. For this purpose, the prepolymers containing isocyanate groups and urethane groups are reacted with compounds which can react with isocyanate groups. The compounds which can react with isocyanate groups are, for example, water, alcohols, amines or compounds containing mercapto groups. The polyurethanes can be foams, in particular installation foams, coatings, adhesives, in particular melt adhesives, paints and compact or cellular elastomers. When they are used as sealants or adhesives, curing to give the finished polyurethane occurs, in the simplest case, by action of atmospheric moisture.

The prepolymers of the invention are preferably also used for producing polyurethane films, in particular films for the food sector. Here, as in the case of use as melt adhesives, in particular hot melt adhesives, coatings or seals, prepolymers based on 2,4′-MDI are particularly useful.

The invention is illustrated by the following examples.

A diisocyanate-free product which contains isocyanate end groups and is made up mainly of oligomers comprising two mol of diphenylmethane diisocyanate (2,4′ isomer) and one mol of a polypropylene glycol having a mean molecular weight of M_{W}=450 g mol⁻¹ (PPG 450) is to be prepared.

### COMPARATIVE EXAMPLE 1

### No Use of Catalysts

To prepare the catalyst-free reference systems, 1 mol of polypropylene glycol having a molecular weight of 450 g/mol (PPG 450) was added dropwise while stirring to a molar excess of diphenylmethane diisocyanate (2,4′ isomer) (table 1) which had been placed in a laboratory reactor at 60° C. and reacted. After the addition was complete, the reaction mixture was maintained at 60° C. for three hours.

The excess diphenylmethane diisocyanate was removed in a short path evaporator to give a monomer-free product having a residual content of free diisocyanate of less than 0.1% by weight and an isocyanate content of about 8.8% by weight of NCO.

Residual monomer content and molecular weight distribution were determined by means of GPC analysis.

TABLE 1
Product distribution of the uncatalyzed prepolymer reaction by means of
GPC analysis after removal of the monomeric isocyanate (figures in
percentages by weight). All percentages are based on the total
amount of oligomeric 2:1, 3:2 and higher isocyanate:polyol adducts.

| | | | | Molecular weight | | |
|---|---|---|---|---|---|---|
| | | | | distribution of | | |
| | | | | product (GPC) [%] | | |
| | | | | Diurethane | | |
| Molar ratio | Mass of | Mass of | | (2:1 adduct; | | |
| of starting | starting | starting | Viscosity | MDI- | | |
| material | material | material | at 50° C. | PPG450- | Triurethane | |
| n_{MDI}:n_{PPG450} | m_{PPG450} [g] | m_{2,4′-MDI} [g] | [Pas] | MDI) | (3:2) | >3:2 |
| 3:1 | 375.0 | 625.0 | 35 | 62.8 | 25.2 | 12.0 |
| 5:1 | 264.7 | 735.3 | 29 | 80.8 | 15.5 | 3.6 |
| 7:1 | 204.7 | 795.3 | 18 | 84.4 | 13.0 | 2.6 |

### EXAMPLE 1

### According to the Invention

Preparation of the Blocking Agent

50.72 g of Pluriol® E 200 (BASF Aktiengesellschaft, Germany) (OHN:553 mg KOH/g, MW: 202.89 g/mol) and 69.67 g of methyl acetoacetate (MW: 116.12 g/mol) were weighed into a four-neck round-bottom flask provided with a downstream distillation attachment cold trap and heated to 140° C. During the reaction, a gentle stream of nitrogen was passed through the flask to remove the methanol formed. After a reaction time of 7 hours, the reaction was stopped. The reaction product was detected by means of GPC. The product was yellow-orange.

The procedure was as in comparative example 1, but 0.002% by weight of dibutyltin dilaurate (DBTL), based on the total amount of polyol and isocyanate components, was added to the PPG 450 in each case.

The distillation was carried out in the presence of 2000 ppm, based on the total mixture, of the blocking agent hydroxyalkyl acetoacetate.

TABLE 2
Product distribution of the prepolymer reaction (cf. comparative example 1)
catalyzed by 20 ppm of DBTL by means of GPC analysis after removal of
the monomeric isocyanate (figures in percent by area).

| | | | | Molecular weight distribution of | | |
|---|---|---|---|---|---|---|
| | | | | product (GPC) [%] | | |
| | | | | Diurethane | | |
| Molar ratio | Mass of | Mass of | | (2:1 adduct; | | |
| of starting | starting | starting | Viscosity | MDI- | | |
| material | material | material | at 50° C. | PPG450- | Triurethane | |
| n_{MDI}:n_{PPG450} | m_{PPG450} [g] | m_{2,4′-MDI} [g] | [Pas] | MDI) | (3:2) | >3:2 |
| 3:1 | 375.0 | 625.0 | 23 | 84.4 | 13.7 | 1.9 |
| 5:1 | 264.7 | 735.3 | 17 | 92.2 | 7.8 | <0.5 |
| 7:1 | 204.7 | 795.3 | 17 | 94.3 | 5.7 | <0.5 |

### EXAMPLE 2

### According to the Invention—in the Presence of Various Concentrations of Dibutyltin Dilaurate

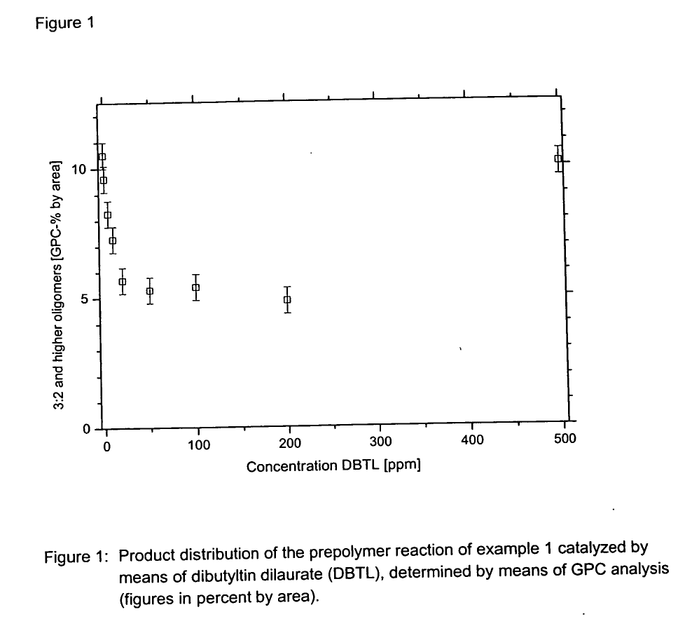

The procedure was as in example 1, but variable concentrations of dibutyltin dilaurate (DBTL), based on the total amount of polyol and isocyanate components, were added to the PPG 450 at a fixed molar 2,4′-MDI:PPG450 ratio of 7:1. The formation of triurethane, viz. the 3:2 adduct of MDI and polyol, and higher molecular weight oligomers is significantly suppressed in a concentration range from 20 to 200 ppm of DBTL, based on the total amount of polyol and isocyanate components. The values are shown in FIG. 1.

### EXAMPLE 3

### According to the Invention—in the Presence of Various Organometallic Catalysts

The procedure was as in example 1, but 0.002% by weight of various catalysts, based on the total amount of polyol and isocyanate components, was added to the PPG 450 at a fixed molar 2,4′-MDI:PPG450 ratio of 7:1 (table 3). Some tin and titanium catalysts 10 reduce the degree of polymerization 1 (proportion of 2:1 adduct ≧92% (GPC)) compared to the comparative example, others have no influence on the product distribution (proportion of 2:1 adduct=90 ±2% (GPC)), while some also promote the formation of oligomeric products.

TABLE 3
Product distribution of the prepolymer reaction (cf. comparative
example 1) catalyzed by 20 ppm of organometallic catalyst by
means of GPC analysis (figures in percent by area).

| | Molecular weight distribution | |
|---|---|---|
| | of product (GPC) [%] | |
| | | Triurethane |
| | Diurethane (2:1- | (3:2) and higher |
| | adduct; MDI- | homologues |
| Catalyst | PPG450-MDI | (>3:2) |
| Dimethyltin dilaurate | 95.1 | 4.9 |
| Dibutyltin dilaurate | 94.3 | 5.7 |
| Dimethylbis(dodecylmercaptide) | 95.9 | 4.1 |
| Dibutylbis(dodecylmercaptide) | 94.5/94.0 | 5.5/6.0 |
| Dioctylbis(dodecylmercaptide) | 95.2/93.6 | 4.8/6.4 |
| Tetra-tert-butyl orthotitanate | 92.7 | 7.3 |
| bis(ethylacetoacetato)titanium(IV) | 92.5 | 7.5 |
| diisopropoxide | | |
| Tetra(2-ethylhexyl)titanium | 92.3 | 7.7 |
| Bismuth(III) tris(2-ethylhexanoate) | 90.4 | 9.6 |
| Iron(III) acetylacetonate | 88.2 | 11.8 |
| Nickel(II) acetylacetonate | 89.6 | 10.4 |
| Vanadium(III) acetylacetonate | 89.9 | 10.1 |
| Tin(II) isooctoate | 88.5 | 11.5 |
| Zirconium(III) propoxide | 81.0 | 19.0 |

### EXAMPLE 4

### According to the Invention—in the Presence of a Heterogeneous Catalyst

a) Preparation of the Heterogeneous Catalyst 6.25 g of dibutyltin dilaurate were made up to a total volume of 23 ml with absolute ethanol. While stirring gently, 25 g of commercially available TIMREX HSAG 100 graphite are added to the impregnation solution. The support was thus impregnated with an amount of impregnation solution corresponding to its ethanol uptake capacity (0.92 ml/g). After an impregnation time of 1 hour, the catalyst was dried at 50° C. for 16 hours in a drying oven.
b) Preparation of the Prepolymer

The procedure was as in example 1, but 0.015% by weight, based on the total amount of polyol and isocyanate components, of the heterogeneous DBTL-activated carbon catalyst was added to the 2,4′-MDI at a fixed molar 2,4′-MDI:PPG450 ratio of 7:1 and was removed from the reaction mixture by filtration after the prepolymer synthesis.

The prepolymer obtained in this way has a viscosity of η=18 Pas at 50° C.

TABLE 4
Product distribution of the prepolymer reaction (cf. comparative example 1)
catalyzed by a heterogeneous DBTL-activated carbon catalyst by means
of GPC analysis after removal of the monomeric isocyanate (figures in
percent by area).

| | | | Molecular weight distribution of | | |
|---|---|---|---|---|---|
| Molar ratio | Mass of | | product (GPC) [%] | | |
| of starting | starting | Mass of starting | Diurethane (2:1; | | |
| material | material | material | adduct; MDI- | Triurethane | |
| n_{MDI}:n_{PPG450} | m_{PPG450} [g] | m_{2,4′-MDI} [g] | PPG450-MDI) | (3:2) | >3:2 |
| 7:1 | 204.7 | 795.3 | 95.0 | 5.0 | <0.5 |

1. A process for preparing prepolymers containing isocyanate groups by reacting
a) diisocyanates with
b) compounds having at least two hydrogen atoms which are reactive toward isocyanate groups in the presence of
c) catalysts, and subsequently separating off the excess monomeric diisocyanates,
wherein
the diisocyanates a) used are unsymmetrical diisocyanates and the catalysts c) used are organometallic catalysts and these organometallic catalysts are removed, blocked or deactivated before the monomeric diisocyanates are separated off.

2. A process according to claim 1, wherein unsymmetrical diisocyanates used are tolylene 2,4′-diisocyanate, diphenylmethane 2,4′-diisocyanate and/or isophorone diisocyanate.

3. A process according to claim 1, wherein the unsymmetrical diisocyanate used is diphenylmethane 2,4′-diisocyanate.

4. A process according to claim 1, wherein the metal catalysts are selected from the group consisting of organometallic compounds of the metals of groups IVA, VA, IVB, VB and VIIIB.

5. A process according to claim 4, wherein the metal catalysts contain ligands.

6. A process according to claim 4, wherein the ligands used are carboxylate anions, alkoxides, enolates, thiolates, mercaptides and alkyl ligands and combinations thereof.

7. A process according to claim 4, wherein the ligands are used in the form of chelating systems.

8. A process according to claim 1, wherein the metal catalysts are selected from the group consisting of dimethyltin, dibutyltin and dioctyltin dilaurate, bis(dodecylmercaptide), bis(2-ethylhexylthioglycolate), diacetate, maleate, bisthioglycerol; octyltin tris(2-ethylhexylthioglycolate), bis(β-methoxycarbonyl-ethyl)tin dilaurate, tetraisopropyl titanate, tetra-tert-butyl orthotitanate, tetra(2-ethylhexyl)titanium and bis(ethylacetoacetato)titanium diisopropoxide, bismuth(III) tris(2-ethylhexanoate) and bismuth laurate.

9. A process according to claim 1, wherein the metal catalysts are homogeneous catalysts.

10. A process according to claim 1, wherein the metal catalysts are heterogeneous catalysts.

11. A process according to claim 1, wherein the metal catalysts have been applied to supports.

12. A process according to claim 1, wherein the organometallic catalysts are deactivated by means of Lewis-acid metal deactivators.

13. A process according to claim 1, wherein the organometallic catalysts are deactivated by means of compounds of the general formula (I)
R₁-X₁-C(X₂,R₂)-(CH₂)ₙ-C(X₃,R₃)-X₄-R₄ (I)
where R₁ and R₄ are, independently of one another, any organic radicals such as a linear, branched or cyclic alkyl radical, a linear, branched or cyclic alkenyl radical, a linear, branched or cyclic hydroxy, halogen, amino or thioalkyl radical, R₂ and R₃ are each, independently of one another, either nothing or hydrogen, X₁ and X₄ are each, independently of one another, either nothing or oxygen, X₂ and X₃ are Lewis-acid substituents, for example a halogen, O, OH, NH_{2,} NO₂, SH and n is an integer from 1 to 5.

14. A process according to claim 13, wherein the compounds of the general formula (I) are organic carboxylic acids which are functionalized on the β-carbon atom (C3) relative to the carbon atom (C1) of the acid group (-C(1)OOH) from the group consisting of β-hydroxycarboxylic acids, β-aminocarboxylic acids, β-ketocarboxylic acids and 1 ,3-dicarboxylic acids and their esters.

15. A process according to claim 13, wherein the compounds of the general formula (I) are selected from the group consisting of citric acid, malic acid, tartaric acid, acetoacetic acid, 2-chloroacetoacetic acid, benzoylacetic acid, acetonedicarboxylic acid, dehydroacetic acid, 3-oxovaleric acid and malonic acid and also the associated esters in each case.

16. A prepolymer which contains isocyanate groups and has a content of monomeric diisocyanates of from 0.01 to 0.5% by weight, based on the weight of the prepolymer, and a content of ABA structures of at least 80% and can be prepared according to claim 1.

17. The method of using compounds of the general formula (I) of claim 13 for the deactivation of organometallic catalysts in the preparation of prepolymers containing isocyanate groups.
